(19) United States
(12) Patent Application Publication
(10) Pub. No.: US 2016/0337417 A1
(43) Pub. Date: Nov. 17, 2016

(54) GROUP CALL SET-UP AND DELIVERY

(71) Applicant: VODAFONE IP LICENSING LIMITED, Newbury, Berkshire (GB)

(72) Inventor: Chris PUDNEY, Newbury, Berkshire (GB)

(21) Appl. No.: 15/111,434

(22) PCT Filed: Jan. 16, 2015
(86) PCT No.: PCT/GB2015/050097

§ 371 Date: Jul. 13, 2016

(30) Foreign Application Priority Data
Jan. 16, 2014 (GB) 1400766.0

(51) Int. Cl. H04L 29/06; H04W 68/02

(52) U.S. Cl. CPC H04L 65/403; H04L 65/80; H04W 68/02

(57) ABSTRACT

Managing a group call between a first device and at least one second device in a telecommunication network may be effected. A communication containing a Quality of Service (Qo S) indicator is communicated, the Qo S indicator being associated with subsequent packets to be delivered to the at least one second device. This communication may be transmitted from and/or received at a node of the telecommunication network associated with a paging area of the at least one second device.

### TECHNICAL FIELD OF THE INVENTION

The invention relates to a method of managing a group call between a first device and at least one second device in a telecommunication network, a corresponding computer program and a corresponding telecommunication network device.

### BACKGROUND

Long Term Evolution (LTE) is a standard of wireless communications of high-speed communications which is described in various standard documents developed by 3GPP (3rd Generation Partnership Project), further enhanced in what is known as LTE-Advanced.

One important feature described of LTE is the ability for groups of user devices to communicate among themselves in what could be labelled as a “group” call.

One mechanism described in the LTE standard is called eMBMS (Multimedia Broadcast Multicast Services) and allows a point-to-multipoint communication for broadcasting and/or multicasting services. One major drawback of this mechanism is that it requires specific resource and network allocation (e.g., a specific bearer is required, etc.) and often, due to spectrum scarcity and the subsequent inability to permanently allocate resources for a service that is not used widely, it is not a good mechanism to be used. In fact, to date, no commercial deployments of this mechanism have been done.

Nevertheless, it may be important that one or more groups of devices are capable of setting-up and/or delivering group calls, in particular Push-To-Talk (PTT) call/communication, to each other using an LTE-type (or other type) cellular network, in a fast, reliable and secure manner. For Emergency Service workers, prompt delivery of PTT speech can be essential and this may require that previously-idle mobiles are rapidly brought into a radio state where they can receive the burst of speech.

### SUMMARY OF THE INVENTION

Against this background, the invention provides a method of managing a group call between a first device and at least one second device in a telecommunication network in accordance with claim 1. A computer program in line with claim 14 may also be considered, although the invention may also be embodied in the form of programmable logic, firmware or other configurable system. A corresponding telecommunication network device as defined by claim 15 is also provided. Other preferred features are disclosed with reference to the claims and in the description below.

There is therefore provided a method of managing a group call in a telecommunication network, the group call being between a first device and at least one second device. The first and second devices may each be a mobile terminal or User Equipment (UE). Each device may be associated with the same or different telecommunication networks. The telecommunication network or networks may each be a mobile telecommunication network. The at least one second device may be in a Radio Resource Control (RRC) Idle mode.

The method may comprise receiving at, transmitting to or transmitting from a node of the network associated with the at least one second device, a communication containing a Quality of Service (QoS) indicator. Advantageously, the QoS indicator is associated with subsequent packets to be delivered to the at least one second device. The node of the telecommunication network associated with the at least one second device may be associated with a paging area of the at least one second device. Typically, the node of the telecommunication network associated with the at least one second device is one of: a Mobility Management Entity (MME) to which the at least one second device may be attached; Serving GPRS Support Node (SGSN) to which the at least one second device may be attached; and one or more (radio) base stations (such as a Node B or an eNodeB) serving the paging area of the at least one second device. The transmitting node is normally associated with a core network of the telecommunication network. The receiving node is normally associated with an access network of the telecommunication network, such as a radio (access) network. Where the node is not a base station, the node may include the received QoS indicator in at least one paging message (and typically multiple paging messages) sent to one or more of the base stations that serve at least a part of a paging area in which the at least one second device is registered and possibly the base station or base stations that serve all of a paging area in which the at least one second device is registered. The communication may be communicated over an Si interface or other Core Network to Radio Network interface.

The subsequent packets may correspond to packets sent from the first device. The packet is preferably a speech packet, such as a Push To Talk (PTT) packet. However, it can also be a data packet, or any combination/alternative type of packet that is supported by the network. The communication containing the QoS indicator may be a paging or alerting message and/or may originate from a core network node (such as an MME or a SGSN) and/or be stimulated by packets sent by a group call management node of the telecommunication network, such as a Group Call Application Server (GC-AS). Advantageously, the use of a QoS indicator, such as one that indicates PTT may mean that the radio interface paging message broadcast by the radio base stations have their transmission delay minimised, for example they do not suffer an extra discontinuous reception delay (a “DRX interval”) when the paging channel is heavily loaded.

The QoS indicator advantageously indicates a level of priority. In a preferred embodiment, the QoS indicator is a QoS class identifier (QCI). The QCI is typically used in LTE for defining the characteristics for delivering an IP packet. For example, TS 23.203 (incorporated herein by reference) describes the QCI in greater detail. Thus, the QCI used for the packet may be a QCI with a high priority, a QCI that guarantees an appropriate level of service in order to provide a rapid and reliable delivery of the packet or a QCI that indicates that ‘best effort’ service is acceptable.

Main advantages of such a solution are that, by means of indicating a QCI in the paging message (sent on the Si interface, for example) to the nodes associated with the recipient (the base stations in the paging area), the paging delay can be minimised and allocation of resources to the devices can be done in a quicker manner than if no QCI was sent with the paging message (as it would happen, for example, in conventional LTE systems).

The method may further comprise triggering, at the node, prompt allocation of resources or prioritisation for communication of packets to/from the second device.

Typically, the method further comprises allocating resources for and/or prioritising/deprioritising the transmission of at least one radio interface paging message from the one or more base stations serving the paging area to the at least one second device in response to the level of priority indicated by the QoS indicator received in the communication from the core network. The at least one radio interface paging message may trigger the device to be configured to receive the packet. Optionally, the method further comprises triggering the retransmission of the at least one radio interface paging message from the base station when the QoS indicator indicates a suitably high requirement on low latency or priority. In particular, retransmission occurs in the event no response is received from the at least one second device. The step of triggering the retransmission of the at least one radio interface paging message may be repeated for a (pre-determined) number of times and/or at regular intervals, especially determined according to the QoS indicator (specifically its contents indicating a QoS and/or priority). Of course, the method may also comprise detecting, at the node, if a response to the second paging message is received from the at least one second device.

The advantage of such steps is that, without such a mechanism, the node may stop paging the device, assuming that the device would have responded to another node of the network. However, when a quick setting up and/or deliver of the PTT communication are required, it may be necessary to minimise the chances that the delay between paging message and subsequent response from the device is minimised. Hence, this repetition mechanism would minimise this risk and guarantee a short delay.

Any or all of the above features and/or methods and/or aspects can be combined in any suitable or compatible manner in order to arrive at additional aspects of the invention without departing from the described invention.

### BRIEF DESCRIPTION OF THE DRAWINGS

The invention may be put into practice in a number of ways, and a preferred embodiment will now be described by way of example only and with reference to the accompanying drawings, in which:

FIGS. 1A and 1B show an exemplary message flow between entities within a mobile telecommunications network according to aspects of the invention.

### DETAILED DESCRIPTION OF A PREFERRED EMBODIMENT

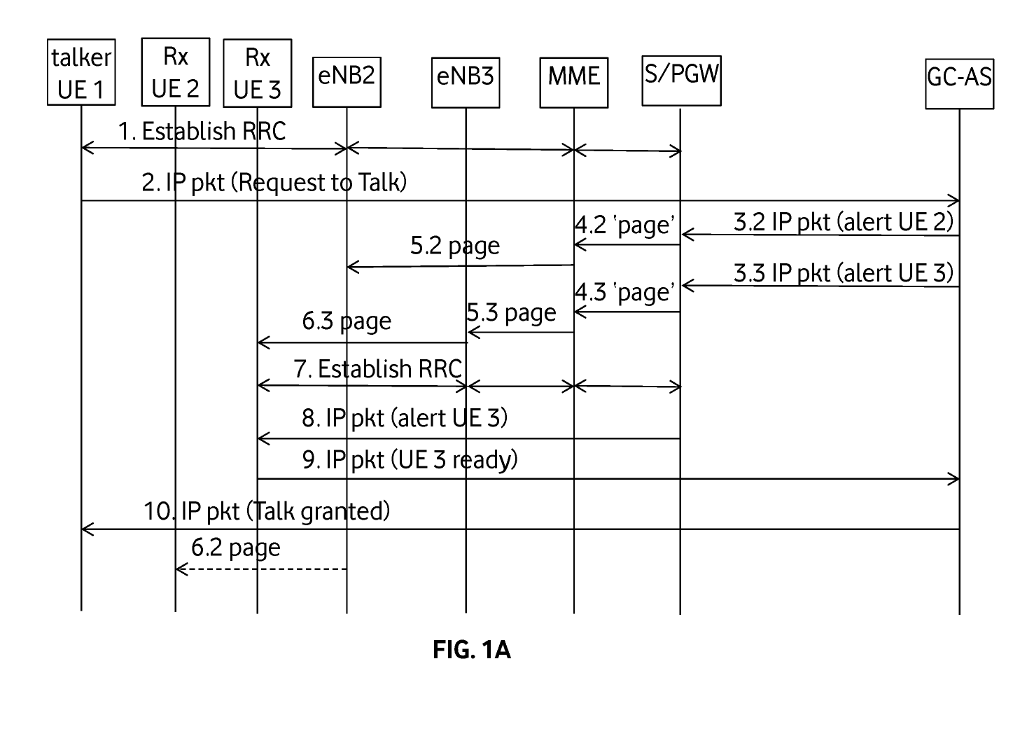

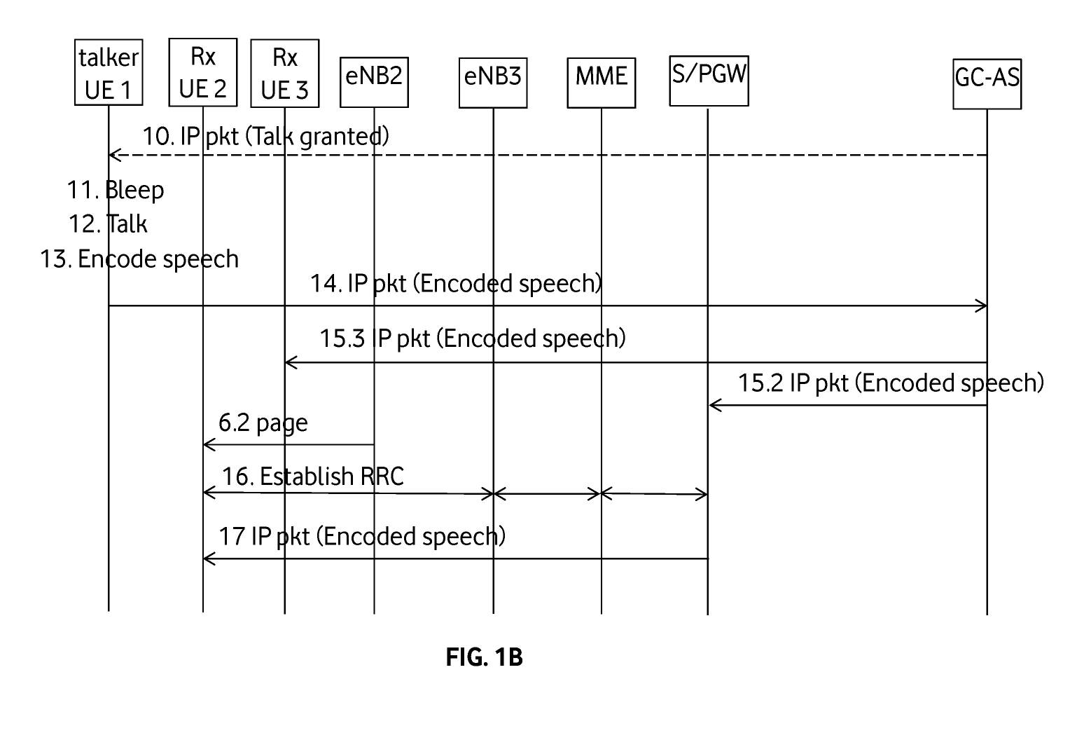

Referring to FIGS. 1A and 1B (collectively referred to as FIG. 1 below), there is shown an exemplary message flow between entities within a mobile telecommunications network. The following is a brief description of the message flow illustrated in FIG. 1, which spans both FIG. 1A and FIG. 1B. The message flow illustrates a method of fast and efficient delivery of speech in a group call. The following description attempts to provide context and elaboration to the content of the illustrated message flow. However, the process will be readily understood by the skilled person when viewing the figures in isolation and without this short description. If at any point this short description appears to contradict the teaching of FIG. 1 to the skilled person then the illustration of FIG. 1 should be considered as the primary and authoritative material.

Illustrated in FIG. 1A are three User Equipment (UEs), talker UE1 and receiver UEs 2 and 3. Also illustrated are two eNodeBs (eNB2, eNB3), a Mobility Management Entity (MME) which is a standardized entity in a System Architecture Evolution (SAE, which is associated with LTE) network dedicated to mobility management, a packet data network gateway (PDN GW or PGW)/Serving GW (SGW), and a Group Call Application Server. For clarity, in this figure UE2 is camped on eNB2 and UE3 is camped on eNB3. Each step in the message flow is annotated with a reference numeral indicating the preferred order in which the message occurs in the flow. This order is of course preferable only. The fractional digit in each reference numeral indicates which UE is associated with (or is the destination for) that message.

The user of the talker UE decides to talk to the rest of their talk group, presses their “Push To Talk” button and at step 1, the talker UE establishes a Radio Resource Control (RRC) connection with the mobile telecommunications network. The Radio Resource Control (RRC) protocol is well known in the art. After the RRC connection has been established, the talker UE sends a Request to Talk IP Packet to the Group Call Application Server (GC-AS) via the network (step 2). This may be a request to establish a PTT communication with UE2 and UE3.

The GC-AS then sends alerts to the remaining members of the group (step 3), here UE2 and UE3, in the form of an IP packet. The alert tells the UEs to be ready to receive speech. The alert is initially sent by the GC-AS to the PDN GW (steps 3.2 and 3.3). The PDN GW matches the IP header of the packet sent by the GC AS against a filter and uses that to select a ‘tunnel’ to send the packet to the SGW. The SGW knows the QCI associated with that ‘tunnel’ and tells the QCI to the MME (steps 4.2 and 4.3).

When UE 2 and UE 3 are in RRC Idle mode, the IP packets carrying the alert are buffered in the SGW and transferred once the paging mechanism and subsequent RRC connection establishment have been completed. The SGW prompts the MME to cause the idle mode UEs to move to RRC connected mode. The MME then sends a page message to the respective eNodeBs in the paging area to which the UE is registered (steps 5.2 and 5.3). The GC-AS may send the alert to all or a portion of the group. The ‘page’ message 5.2 is typically sent from the MME to all the eNodeBs that serve the Tracking Area List in which UE2 is registered; and similarly ‘page’ message 5.3 is typically sent from the MME to all the eNodeBs that serve the Tracking Area List in which UE3 is registered. These are not shown in FIG. 1A, however, for clarity's sake.

Typically a PTT UE wakes every 320 ms to receive a page. This parameter is usually set in the UE, and it has an effect on the battery used by the UE—the more often the UE wakes up, the more battery is used. In the scenario represented in the figure, each UE is paged separately and the process carries on without all UEs being ready. As soon as one UE is ready for receiving, the speech is transmitted.

The occasions when different base stations page the UEs are typically randomly distributed (with uniform distribution) over the DRX interval. For example, for 320 ms DRX interval, the delay from step 5.3 to step 6.3 might be a few (3 to 10) milliseconds while the delay from step 5.2 to step 6.2 could be 319 milliseconds. Once the page has been received by the UE, the UE moves from RRC Idle to RRC connected states by signalling through the eNodeB to the MME. The MME tells the eNodeB what resources and QCIs to establish.

Thus, the Receiving UE establishes an RRC connection to the network upon receipt of the page message from the respective serving eNodeB (step 7). Illustrated first is the UE3 receiving the page. Once the UE has established an RRC connection with the network, the alert can be transmitted as an IP packet (step 8). The UE 3 then indicates to the GC-AS that it is ready to receive a transmission or speech packet (step 9).

The GC-AS then sends a ‘Talk Granted’ packet to the talker UE—for example, once at least one of the Receiver UEs has confirmed they are ready (step 10). The eNodeB serving the other receiver UE continues to page the other UE2 until the page is received (step 6.2).

Upon receipt of the talk granted packet from the GC-AS, the UE notifies the talker that the service is ready, preferably through a bleep (step 11). The talker then talks (step 12) and the UE1 buffers the speech and encodes it (step 13). The encoded speech is then sent to the GC-AS (step 14). At step 15, the speech is sent from the GC-AS directly to the ready UE3 for decoding and playback and to the P-GW for sending when UE2 has established an RRC connection (in this case, the P-GW may buffer it, directly or indirectly, for future delivery).

When the eNodeB eNB2 pages the UE UE2 (step 6.2), UE2 establishes an RRC connection (step 16). The S-GW then sends the stored speech to the UE2 for decoding and playback (step 17).

Whilst the above detailed embodiment explains the working of the invention in depth, a generalised description of the invention in a number of aspects has been provided above. For example, there are provided methods of managing a group call between a first device and at least one second device in a telecommunication network. The method comprises communicating to or from (that is one or more of: receiving at; transmitting from; transmitting to) a node of the network associated with the at least one second device, a communication containing a QoS indicator. Preferably, the communication is sent to and/or received at one or more base stations serving at least part of a paging area in which the at least one second device is registered. The QoS indicator may be associated with subsequent packets to be delivered to the at least one second device.

One important advantage of sending the packet using the mechanisms described herein is that the delivery of the radio interface page can be prioritised over the delivery of other paging messages. This is because a node of an LTE network (such as an eNodeB) is configured to give the highest priority to IMS bearers—even above Guaranteed Bit Rate (GBR) bearers. Using the QCI, it is possible to specify a QoS level such that the packet is prioritised, then quickly and safely delivered to the second device. The QCI for PTT is ‘service dependent’ and thus rather different to the ‘paging priority level’ which is related to the importance of the user (for instance, president, chief police office, ordinary police, etc.). For non-PTT calls, delay in the paging of one or two DRX cycles may not matter, provided the page does get sent. However, for PTT speech bursts, delay can be very important. Moreover, using an IMS bearer to deliver a packet to the second device may further help to guarantee that the delivery of this packet is prioritised, and hence the delay between the time when the packet is sent by the first device and the time at which the second device receives the packet is minimised.

In particular, in case of push-to-talk (PTT) communications, as described above, a user typically requests to send a communication (such as to talk) to one or more recipients, typically by pressing a special button on the user device. Once the communication is set up, the message is then delivered to the recipients' devices. In LTE, any communication is converted into an IP packet which is then delivered via the network. Setting-up and delivering a PTT communication may have different challenges from a normal voice/data call communication. In particular, there may be a significant delay between the time the PTT communication is sent and the time the PTT communication is received.

This delay may be acceptable in certain circumstances, but in other scenarios is of uppermost importance that this delay is minimised. For example, in case of personnel of emergency services needing to communicate with each other in a high priority situation (for example, a situation where lives are put at risks, or where a quick response is vital), making sure that the communications are delivered in real/near-real time is very important. If the PTT communication is to be sent and delivered using conventional procedures in an LTE network, there would be nothing that would guarantee that this message is delivered with a minimum delay (for example, less than 200-300 ms). However, by using the solution described above, it would be possible to guarantee that such stringent requirements on minimum delay are respected. This is because, as discussed above, by using an appropriate QCI (for instance, see above for discussion about QCI) appropriate prioritisation could be effected. In addition, because the LTE network prioritises an IMS bearer over any other bearer, use of this can further enhance the improvement.

Some optional features applicable to the invention have been described above, but further optional features will now be detailed in a generalised sense.

For example, the method may further comprise receiving an alerting message from the group call management node of the telecommunication network (such as the GC-AS) at a Serving Gateway (SGW) or Packet Data Network Gateway (PGW) of the telecommunication network. Then, the method may further comprise communicating a paging message based on the alerting message. In the context of this disclosure, communicating is used to refer to transmitting and/or relaying and/or receiving, as noted above. The paging message may be communicated to a Mobility Management Entity (MME) of the telecommunication network. In the preferred embodiment, the method further comprises communicating the paging message from the MME to the node of the telecommunication network associated with the paging area of the at least one second device.

In embodiments, the method further comprises establishing a Radio Resource Control, RRC, connection between the first device and the mobile telecommunications network. The RRC connection may establish a communication path with a Serving Gateway (SGW) or Packet Data Network Gateway (PGW) of the telecommunications network.

In the preferred embodiment, the method further comprises communicating a request to talk message from the first device to the group call management node of the telecommunication network.

Optionally, the method further comprises establishing a Radio Resource Control (RRC) connection between the at least one second device and the mobile telecommunications network (in particular with the SGW or PGW), in particular in response to communication of the paging message from the node of the telecommunication network associated with the at least one second device to the at least one second device.

In some embodiments, the method further comprises communicating the alerting message from the SGW or PGW of the telecommunication network to the at least one second device.

Preferably, the method further comprises communicating a device ready message from the at least one second device to the group call management node of the telecommunication network. Optionally, the method further comprises communicating a talk granted message from the group call management node of the telecommunication network to the first device, in response to receipt of the device ready message from the at least one second device.

In the preferred embodiment, the method further comprises communicating one or more information packets (which may form the basis of the subsequent data packets and may comprise speech and/or audio and/or data) from the first device to the group call management node of the telecommunication network. Then, the method optionally further comprises communicating the one or more information packets from the group call management node of the telecommunication network (such as the GC-AS) to the at least one second device. The one or more information packets may be communicated from the group call management node of the telecommunication network to the at least one second device via a SGW or PGW of the telecommunication network until the at least one second device has established an RRC connection with the telecommunication network.

According to an aspect ancillary to the invention, there is further provided a first method of managing a group call in a telecommunication network, the group call being between a first device and at least one second device. Each device may be associated with the telecommunication network. The method may comprise receiving, at the at least one second device, a packet over a high priority bearer, wherein the packet corresponds to a packet sent from the first device. The packet is preferably a speech packet. However, it can also be a data packet, or any combination/alternative type of packet that is supported by the network. In a preferred embodiment, the bearer is an IP Multimedia Subsystem (IMS) bearer. The packet may be delivered by a node of the network associated with the at least one second device (for instance, the node to which the at least one second device is attached). In addition, the packet may also be associated with a quality of service indicator. In a preferred embodiment, this indicator is a QoS class identifier (QCI). The QCI may be sent in a communication to the node associated with the at least one second device (for instance, by using the method discussed in relation to the main aspects of the invention). The method may further comprise determining, at the node or another element of the network, that the packet is associated with a QCI and, based on said determination, (further) prioritising the packet delivery in accordance with a priority associated with the QCI. The method may further comprise determining, at the node or another element of the network, that the packet is associated with a particular QCI and is transmitted over a related bearer and, based on said determination, prioritising the packet delivery in accordance with a priority associated with the QCI and/or the network configuration.

Although a specific embodiment has been described, the skilled person will understand that variations and modifications are possible. For example, the specific network entities and architectures can be varied.

As a final remark, all the technical specifications, standards and/or protocols cited throughout this whole specification either by way of explicit mentioning (e.g., 3GPP TS 23.203, 23.401, 36.413, 36.331, etc.) or by implicit mentioning (e.g., “as explained by 3GPP specifications”) are hereby incorporated by reference in their entirety. Also, although the invention has been described in conjunction with an LTE network, the same principles could be applied to another type of network (e.g., a 3G network) provided that the functionalities described are compatible with the alternative network and by using the equivalent elements (and associated terminologies) of the alternative network to perform the described steps.

1. A method of managing a group call between a first device and at least one second device in a telecommunication network, the method comprising:
communicating to or from a node of the telecommunication network associated with the at least one second device, a communication containing a Quality of Service, QoS, indicator, the QoS indicator being associated with subsequent packets to be delivered to the at least one second device.

2. The method of claim 1, wherein the step of communicating to a node of the telecommunication network associated with the at least one second device comprises receiving the communication at a base station serving at least a part of a paging area in which the at least one second device is registered.

3. The method of claim 2, further comprising:
allocating resources for, prioritising or deprioritising the transmission of at least one paging message from the base station to the at least one second device in response to receipt of the communication containing the QoS indicator.

4. The method of claim 3, further comprising:
triggering the retransmission of the at least one paging message from the base station to the at least one second device in the event that no response is received from the at least one second device.

5. The method of claim 4, wherein the step of triggering the retransmission of the at least one paging message is repeated for a number of times and/or at regular intervals.

6. The method of claim 5, wherein the one or both of the number of times and the regular intervals are determined on the basis of the QoS indicator.

7. The method of any preceding claim, wherein the subsequent packets correspond with packets sent from the first device.

8. The method of claim 7, wherein the packets sent from the first device comprise one or both of: a speech packet; and a data packet.

9. The method of any preceding claim, wherein the communication containing the QoS indicator is a paging or alerting message sent between nodes of the telecommunication network.

10. The method of any preceding claim, wherein the QoS indicator is a QoS Class Identifier, QCI.

11. The method of any preceding claim, further comprising:
allocating resources for the transmission of the subsequent packets in accordance with a QoS indicated by the QoS indicator.

12. The method of any preceding claim, wherein the communication containing the QoS indicator is sent from a node of a core network part of the telecommunication network.

13. The method of claim 12, wherein the communication containing the QoS indicator is sent to a radio access network node of the telecommunication network from one of: a Mobility Management Entity, MME, of the telecommunication network; a Serving GPRS Support Node, SGSN, of the telecommunication network; a Packet Data Network Gateway, PDN GW, of the telecommunication network; and a Serving Gateway, SGW, of the telecommunication network.

14. A computer program configured to carry out the method of any preceding claim when operated by a processor.

15. A telecommunication network device configured to operate in accordance with any of claims 1 to 13.
